(19) United States
(12) Patent Application Publication
(10) Pub. No.: US 2012/0250631 A1
(43) Pub. Date: Oct. 4, 2012

(54) Multiplexing Logical Channels in Mixed Licensed and Unlicensed Spectrum Carrier Aggregation

(75) Inventors: Sami-Jukka Hakola, Kempele (FI); Timo K. Koskela, Oulu (FI); Samuli Turtinen, Il (FI)

(73) Assignee: Renesas Mobile Corporation

(21) Appl. No.: 13/076,602

(22) Filed: Mar. 31, 2011

(51) Int. Cl. H04W 72/04

(52) U.S. Cl. 370/329

(57) ABSTRACT

Downlink control signaling from a network to a user equipment UE associates at least a first logical channel or radio bearer with a first component carrier in a licensed frequency band and associates at least a second logical channel or radio bearer with a second component carrier in an unlicensed frequency band. The UE uses the associations to select which uplink data is sent on the first and on the second component carriers by multiplexing the uplink data on the at least first and the at least second logical channels or radio bearers. By example the downlink control signaling may be a MAC control element in a RRC_Connection_Reconfiguration message which semi-statically defines a multiplexing allowance for each of the logical channels or radio bearers. An example MAC control element has an information tuple giving the association and multiplexing status per channel/bearer. Certain embodiments also adapt transmit power scaling for licensed/unlicensed band operation.

### TECHNICAL FIELD

The exemplary and non-limiting embodiments of this invention relate generally to wireless communication systems, methods, devices and computer programs and, more specifically, relate to prioritizing channels in both licensed and unlicensed spectrum for multiplexing purposes, and control signaling to coordinate networks with user equipment for such prioritizing and multiplexing.

### BACKGROUND

The following abbreviations that may be found in the specification and/or the drawing figures are defined as follows:

3GPP third generation partnership project

CA carrier aggregation

CC component carrier

eNB node B/base station in an E-UTRAN system

DL downlink

E-UTRAN evolved UTRAN (LTE)

HARQ hybrid automatic repeat request

ISM industrial, scientific and medical

LTE long term evolution

MAC medium access control

PCC primary component carrier

PDCCH physical downlink control channel

PDCP packet data convergence protocol

PUCCH physical uplink control channel

PUSCH physical uplink shared channel

QoS quality of service

RAT radio access technology

RLC radio link control

RRC radio resource control

SCC secondary component carrier

UE user equipment

UL uplink

UTRAN universal terrestrial radio access network

TV WS television white spaces

Due to increasing volumes of users and data in licensed frequency bands there is ongoing research into exploiting at least some portions of unlicensed radio spectrum for use in structured wireless communications. Such unlicensed spectrum bands are sometimes termed shared bands and for example include the ISM band and the TV white spaces which the US Federal Communications Commission FCC is considering for this use. Network operators, service providers, communication device manufacturers, and communication system manufacturers therefore seek efficient solutions for reliable operation within unlicensed shared bands. Communication on an unlicensed shared band is generally based on sharing an available channel between different communication devices, which may utilize a common RAT or in certain scenarios different RATs. In an unlicensed shared band, interference among the various devices can be avoided by distributing the channel access. For example, communication devices can detect a channel and utilize some channel reservation scheme known to other communication devices in order to reserve a right to access the channel. In distributed channel access, a transmitting communication device and a receiving communication device are generally not synchronized to a global reference.

There is some study into extending the LTE system so as to utilize these unlicensed bands in a somewhat structured way and FIG. 1 is a schematic bandwidth diagram illustrating that concept. First consider LTE Release 10 which is yet to be finalized but is intended to utilize a carrier aggregation in which the whole licensed system bandwidth is divided into various CCs (sometimes termed cells). Any given UE will be configured with one PCC 100 and potentially one or more SCCs 101 in the licensed bandwidth. This allows the eNB scheduler to more efficiently distribute traffic to meet the target peak data rates of 1 Gpbs in the DL and half that in the UL, while still enabling backward compatibility with user devices which are not capable of multiple CC operation.

In extending the CA concept of LTE Release 10 to unlicensed bands, a given UE will be configured with a PCC 100 on the licensed band and possibly also one or more SCCs 102, 103 in the unlicensed band (with or without one or more SCCs in the licensed band). This enables user devices and local access points to have potentially more spectrum available beyond only the licensed band. The unlicensed bands are to be used opportunistically. FIG. 1 illustrates that one or more unlicensed SCCs 103 (e.g., in the ISM band) can be frequency non-contiguous with the licensed spectrum as well as with other unlicensed SCCs 102 (e.g., in the TV WS band). In this concept some but not all of the interference avoidance arises from the user devices being scheduled from the eNB which controls their operation in the unlicensed band.

In the unlicensed band the eNB cannot be assured it controls all devices operating there and so there may be interference from other devices not under control of or even known to the eNB. As compared to the licensed band CCs then, the eNB schedules resources in the unlicensed SCCs with less assurance those scheduled radio resources (channels) will be interference-free at the exact time for which they are scheduled. Assume for example that in LTE Release 10 (which utilizes CA exclusively in licensed spectrum), the eNB schedules resources on the PCC 100 and on the SCC 101 for one UE and in one PDCCH/allocation. If that UE multiplexes its data from different radio bearers onto the different allocated CCs 100, 101, LTE Release 10 allows the UE to decide in which order to fill those granted/allocated resources.

The inventors consider this approach less than optimum for the case in which one or more of the SCCs lay in the unlicensed band such as TV WS or ISM. This is because in the unlicensed bands interference conditions are dynamically changing and sometimes indeterminate in advance, and additionally there are different limitations on the UE's transmit power in the unlicensed bands. The invention detailed below by specific but non-limiting examples address this issue of multiplexing channels across multiple CCs lying in both licensed and unlicensed frequency bands.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: utilize downlink control signaling to associate at least a first logical channel or radio bearer with a first component carrier in a licensed frequency band and to associate at least a second logical channel or radio bearer with a second component carrier in an unlicensed frequency band; and utilize the associations to control which uplink data is sent on the first and on the second component carriers by multiplexing the uplink data on the at least first and the at least second logical channels or radio bearers.

In a second exemplary embodiment of the invention there is a method comprising: utilizing by an apparatus downlink control signaling to associate at least a first logical channel or radio bearer with a first component carrier in a licensed frequency band and to associate at least a second logical channel or radio bearer with a second component carrier in an unlicensed frequency band; and utilizing the associations to control by the apparatus which uplink data is sent on the first and on the second component carriers by multiplexing the uplink data on the at least first and the at least second logical channels or radio bearers.

In a third exemplary embodiment of the invention there is a computer readable memory storing a set of instructions, which, when executed by an apparatus, causes the apparatus to: utilize downlink control signaling to associate at least a first logical channel or radio bearer with a first component carrier in a licensed frequency band and to associate at least a second logical channel or radio bearer with a second component carrier in an unlicensed frequency band; and utilize the associations to control which uplink data is sent on the first and on the second component carriers by multiplexing the uplink data on the at least first and the at least second logical channels or radio bearers.

In a fourth exemplary embodiment of the invention there is an apparatus comprising at least one processor and at least one memory storing a computer program. In this embodiment the at least one memory with the computer program is configured with the at least one processor to cause the apparatus to at least: associate at least a first logical channel or radio bearer with a first component carrier in a licensed frequency band; associate at least a second logical channel or radio bearer with a second component carrier in an unlicensed frequency band; and arrange downlink control signaling to inform a user equipment of the associations for use in multiplexing uplink data on the at least first and the at least second logical channels or radio bearers.

In a fifth exemplary embodiment of the invention there is a method comprising: associating by an apparatus at least a first logical channel or radio bearer with a first component carrier in a licensed frequency band; associating by the apparatus at least a second logical channel or radio bearer with a second component carrier in an unlicensed frequency band; and arranging by the apparatus downlink control signaling to inform a user equipment of the associations for use in multiplexing uplink data on the at least first and the at least second logical channels or radio bearers.

In a sixth exemplary embodiment of the invention there is a computer readable memory storing a set of instructions, which, when executed by an apparatus, causes the apparatus to: associate at least a first logical channel or radio bearer with a first component carrier in a licensed frequency band; associate at least a second logical channel or radio bearer with a second component carrier in an unlicensed frequency band; and arrange downlink control signaling to inform a user equipment of the associations for use in multiplexing uplink data on the at least first and the at least second logical channels or radio bearers.

These and other embodiments and aspects are detailed below with particularity.

### BRIEF DESCRIPTION OF THE DRAWINGS

FIG. 1 is a schematic frequency diagram showing a carrier aggregation system in which some component carriers lay in a licensed band and some lay in unlicensed bands.

FIG. 2 is a schematic diagram illustrating a protocol stack in a UE for the LTE system which may be retained unchanged for certain implementations of these teachings.

FIGS. 3-4 are logic flow diagrams that each illustrates the operation of a method, and a result of execution by an apparatus of a set of computer program instructions embodied on a computer readable memory, in accordance with the exemplary embodiments of this invention.

FIG. 5 is a simplified block diagram of a UE and an eNB which are exemplary electronic devices suitable for use in practicing the exemplary embodiments of the invention.

### DETAILED DESCRIPTION

Exemplary embodiments of the invention described herein provide a mechanism by which the network operating in the licensed band provides information to the user device as to which user data (e.g., which logical channel) can be sent on unlicensed versus licensed CCs when the user data is multiplexed on both. In one embodiment this information may be considered as priority information for each logical channel/radio bearer indicating whether or not the user data, to be sent on a transport/physical channel which maps to that logical channel/radio bearer, may be sent on a CC lying in unlicensed spectrum. In various embodiments detailed below such priority information may be semi-statically configured by the eNB via RRC signaling, or it may be dynamically changed via MAC level signaling. The network can utilize such RRC or MAC signaling to control different types of uplink user data (e.g., delay sensitive versus best efforts) being sent in the different types of frequency spectrum bands, licensed versus unlicensed.

Even beyond the licensed versus unlicensed band distinction, this is quite different from how CA operates in LTE Release 10 (sometimes termed LTE-Advanced or LTE-A). Specifically, LTE Release 10 puts the decision on the UE for how to multiplex and so the UE chooses in which order to fill the scheduled CCs with its UL data. This is seen to be implementation specific, and so different UE manufacturers might make different choices as to how and what order to fill UL resource grants that span two or more CCs. Embodiments of these teachings can simply add on to those prior art implementations so that these teachings are implemented only for the case in which there is an UL resource grant for a CC in the unlicensed band, or these teachings may more fundamentally change even UL grants lying only in the licensed band so that all logical channels/radio bearers for all UL allocations are associated via network signaling with a specific CC. The logical channel multiplexing detailed below also gives rise to a new way for the UE to perform power scaling of its UL transmissions on those granted UL resources, which is different from the power scaling regimen provided by LTE Release 10.

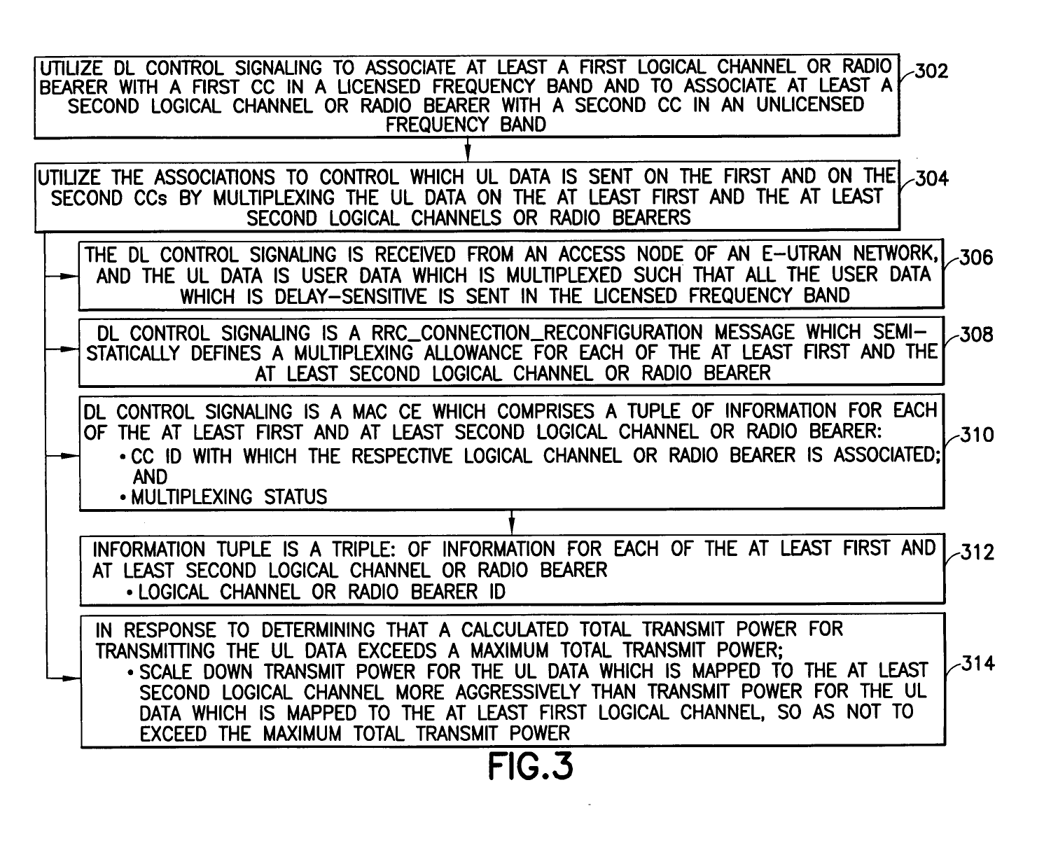

In order to better appreciate these distinctions, first are described some relevant operations for the LTE Release 10 system as that system is currently developed. FIG. 2 illustrates a UE protocol stack 200 for the LTE Release 10 system; the stack in the eNB is similar but lacking the network access stratum NAS 202. The packet data convergence protocol layer 206 falls between the RRC layer 204 and the radio link control RLC layer 208. While the PDCP 206 and RLC 208 layers are each shown as a single block, in fact there is a different PDPC entity and RLC entity for each of the radio bearers, indicated by the three heavy vertical arrows. The RLC layer 208 handles the logical channels such as the paging, broadcast, dedicated and common control channels PCCH, BCCH, DCCH, CCCH; and the dedicated traffic channel DTCH. The physical PHY layer 212 handles the physical channels such as the physical broadcast channel PBCH; physical downlink and uplink control channels PDCCH, PUCCH; physical downlink and uplink shared channels PDSCH, PUSCH; physical HARQ indicator channel PHICH; and the physical random access channel PRACH. Between the RLC layer 208 and the PHY layer 212 lies the MAC layer 210 which maps between the logical channels and transport channels such as the paging and broadcast channels PCH, BCH; downlink and uplink shared channels DL-SCH, UL-SCH; and the random access channel RACH.

Certain exemplary embodiments of these teachings do not change this protocol stack but rather provide signaling from the network to overcome the fact that in the UE the different PDCP and RLC entities for the different bearers are blind to their peer PDCP and RLC entities and bearers in the same UE.

In LTE Release 10, the protocol separation to different carriers is done inside MAC layer 210, thus the PDCP 206 and the RLC 208 protocols in Release 10 are the same as defined in Releases 8 and 9. Since there is one PDCP and RLC entity per radio bearer as noted above, the RLC layer 208 cannot see on how many components carriers the physical layer transmission is performed. When the UE is scheduled multiple uplink CCs, the UE decides in which order it utilizes the received UL scheduling grants, and how to multiplex data from different radio bearers onto allocated CCs according to logical channel priorities and prioritization rules.

In a particular embodiment, the logical channel prioritization is signaled in the LogicalChannelConfig information element (IE) as part of the RRCConnectionReconfiguration or RRCConnectionSetup to the UE. 3GPP TS 36.331 v10.0.0 (2010-12) specifies the content of the IE LogicalChannelConfig at section 6.3.2 as follows:

-- ASN1START
LogicalChannelConfig ::= SEQUENCE {

ul-SpecificParameters SEQUENCE {

priority INTEGER (1..16),
prioritisedBitRate ENUMERATED {

kBps0, kBps8, kBps16, kBps32, kBps64, kBps128,
kBps256, infinity, spare8, spare7, spare6,
spare5, spare4, spare3, spare2, spare1},

bucketSizeDuration ENUMERATED {

ms50, ms100, ms150, ms300, ms500, ms1000, spare2,
spare1},

logicalChannelGroup INTEGER (0..3) OPTIONAL -- Need OR

} OPTIONAL, -- CondUL
...,
[[ logicalChannelSR-Mask-r9 ENUMERATED {setup}
OPTIONAL -- Cond

SRmask]]
}
- ASN1STOP

The above multiplexing of data from different radio bearers onto allocated CCs is done within the MAC layer 210.

Respecting the LTE Release 10 multiplexing, 3GPP TS 36.321 v10.0.0 (2010-12) specifies the logical channel prioritization at section 5.4.3.1 as follows:
The Logical Channel Prioritization procedure is applied when a new transmission is performed.
RRC controls the scheduling of uplink data by signalling for each logical channel: priority where an increasing priority value indicates a lower priority level, prioritisedBitRate which sets the Prioritized Bit Rate (PBR), bucketSizeDuration which sets the Bucket Size Duration (BSD).
The UE shall maintain a variable Bj for each logical channel j. Bj shall be initialized to zero when the related logical channel is established, and incremented by the product PBR×TTI duration for each TTI, where PBR is Prioritized Bit Rate of logical channel j. However, the value of Bj can never exceed the bucket size and if the value of Bj is larger than the bucket size of logical channel j, it shall be set to the bucket size. The bucket size of a logical channel is equal to PBR×BSD, where PBR and BSD are configured by upper layers.
The UE shall perform the following Logical Channel Prioritization procedure when a new transmission is performed:
   The UE shall allocate resources to the logical channels in the following steps:
   Step 1: All the logical channels with Bj>0 are allocated resources in a decreasing priority order. If the PBR of a radio bearer is set to “infinity”, the UE shall allocate resources for all the data that is available for transmission on the radio bearer before meeting the PBR of the lower priority radio bearer(s);
   Step 2: the UE shall decrement Bj by the total size of MAC SDUs served to logical channel j in Step 1
NOTE: The value of Bj can be negative.
   Step 3: if any resources remain, all the logical channels are served in a strict decreasing priority order (regardless of the value of Bj) until either the data for that logical channel or the UL grant is exhausted, whichever comes first. Logical channels configured with equal priority should be served equally.
The UE shall also follow the rules below during the scheduling procedures above:
   the UE should not segment an RLC SDU (or partially transmitted SDU or retransmitted RLC PDU) if the whole SDU (or partially transmitted SDU or retransmitted RLC PDU) fits into the remaining resources;
   if the UE segments an RLC SDU from the logical channel, it shall maximize the size of the segment to fill the grant as much as possible;
   UE should maximise the transmission of data.
The UE shall not transmit data for a logical channel corresponding to a radio bearer that is suspended (the conditions for when a radio bearer is considered suspended are defined in [8]).
For the Logical Channel Prioritization procedure, the UE shall take into account the following relative priority in decreasing order:
   MAC control element for C-RNTI or data from UL-CCCH;
   MAC control element for BSR, with exception of BSR included for padding;
   MAC control element for PHR;
   data from any Logical Channel, except data from UL-CCCH;
   MAC control element for BSR included for padding.
   NOTE: When the UE is requested to transmit multiple MAC PDUs in one TTI, steps 1 to 3 and the associated rules may be applied either to each grant independently or to the sum of the capacities of the grants. Also the order in which the grants are processed is left up to UE implementation.

There is also a functionality in LTE Release 10 UEs for physical layer power scaling, by which the UE scales down its calculated transmission power when the total transmit power exceeds the UE's maximum transmit power. It appears to the inventors that LTE Release 10 carrier aggregation requires equal power scaling among the allocated CCs.

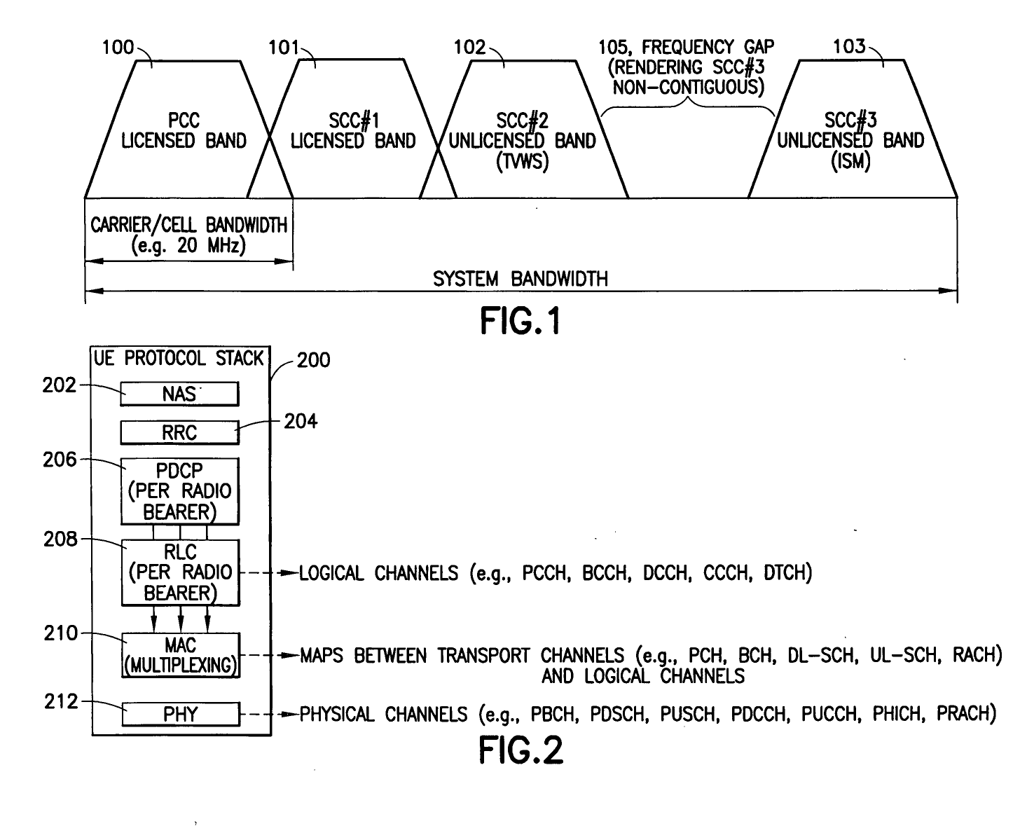

Understanding from above exactly how channel prioritization is handled in the LTE Release 10 system (e.g., at the UE's discretion), now are detailed certain embodiments of the invention which were summarized in the overview provided at the start of the Detailed Description section. Assume the initial condition that the network has granted UL radio resources to a UE, in which the UL radio resources lie in a first CC in the licensed band and also in a second CC in the unlicensed band. In various embodiments there is RRC or MAC level signaling which respectively allow semi-static or dynamic network controlled logical channel prioritization and data multiplexing in the MAC layer 210 onto allocated uplink CCs for the mixed licensed and unlicensed spectrum carrier aggregation. By way of illustration, the first CC may be the PCC 100 or the SCC#1 101 of FIG. 1, and the second CC may be either of SCC#2 102 or SCC#3 103 shown at FIG. 1. Of course the UE may be allocated resources in more than two CCs, in which case allocations in the third, fourth, etc. CC are handled as are the first and second CC depending on whether those additional CCs of the further allocations are in licensed or unlicensed bands.

In the embodiment utilizing RRC level signaling, the eNB may semi-statically define for each logical channel/radio bearer whether data on that logical channel/radio bearer could be transmitted on a certain unlicensed spectrum CC. By example this RRC level signaling may be within a RRC_Connection_Reconfiguration message, modified according to these teachings to include a list or bitmap for each logical channel and configured component carrier to indicate the multiplexing allowance of certain logical channel data onto a certain configured component carrier. The UE will then store this list/bitmap in its local memory for use throughout the time the eNB which sent it is the UE's serving eNB. It may be that some logical channels in this list are never utilized by the UE which may be transient through the cell, but this RRC level signaling is only semi-static so providing a full list gives the eNB the greatest flexibility to schedule resources for the UE as it moves through the cell.

In the embodiment utilizing MAC level signaling, the eNB is enabled to more dynamically change the multiplexing status per each radio bearer, which the eNB may do based on more instantaneous characteristics of the served unlicensed spectrum CC. That is, the eNB may change the multiplexing status based on channel measurements the eNB takes itself in the unlicensed band, or based on measurement results of the unlicensed band which the eNB receives from the subject UE or from other UEs. This MAC level signaling may be implemented by non-limiting example by a new MAC control element CE which is defined by specifications to include an information tuple (e.g., double or triple) for each logical channel. Since this is dynamic signaling, in certain cases the eNB need only signal the CE for a logical channel whose information tuple has changed since the last time it was signaled to the subject UE. Such an information triple would in this embodiment include an identifier of the logical channel to which the tuple applies, an identifier of the unlicensed spectrum CC (e.g., a CC index), and the multiplexing status of the logical channel, whether the logical channel (e.g., data on it) is allowed to be multiplexed onto a CC in the unlicensed band. If instead the system specifications were such that there were some default multiplexing status for each relevant (UL) logical channel, then this new CE need only be an information double identifying the logical channel and the changed multiplexing status (changed from the default status or from whatever previous status was signaled for that logical channel).

By the above RRC or MAC layer signaling, the eNB could associate specific logical channels to specific CCs and thereby configure the UE to send delay sensitive (and/or QoS-sensitive) data on CCs which are on the licensed spectrum, and to send best effort data on the unlicensed spectrum. Since this is configurable by the eNB, the above solutions enable a fast response capability to the changing conditions which is particularly valuable for the CCs in the unlicensed spectrum. These solutions also enable an efficient adaptation of different QoS requirements of the UE's service flows onto the available radio resources.

Multiplexing the various logical channels onto different CCs in both the licensed and unlicensed bands might, like conventional LTE Release 10, sometimes result in the calculated transmit power exceeding the UE's maximum allowable transmit power. In this case, rather than scaling equally so as not to exceed the maximum transmit power as LTE Release 10 appears to require, certain embodiments of these teachings have the UE take into account the current status of the allowed logical channel multiplexing on the different CCs over licensed and unlicensed spectrum. In this power scaling adaptation, the UE prioritizes the order of CCs to which the power down-scaling is done so that CCs that are configured with the capability to multiplex lower priority logical channels (e.g., the CCs in the unlicensed band) are scaled either first or with a higher impact (greater power reduction) than CCs with the capability to transmit higher priority logical channels. More generally, power scaling on the logical channels associated with the unlicensed band CC(s) is more aggressive than power scaling on the logical channels associated with the licensed band CC(s).

Exemplary embodiments of these teachings as detailed above provide the technical effect of new and effective means by which to take into account the indeterminate nature of unlicensed spectrum in layer 2 signaling for multiplexing different logical data onto allocated component carriers utilizing both licensed and unlicensed spectrum.

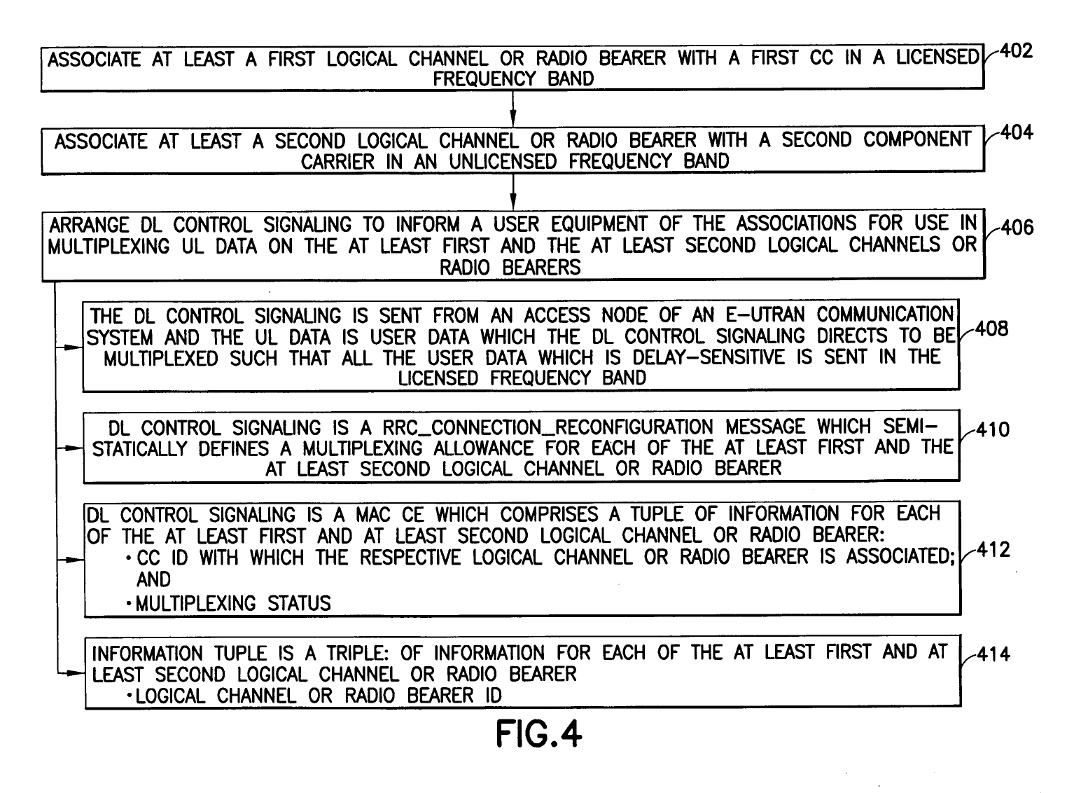

FIGS. 3-4 are logic flow diagrams which describes exemplary embodiments of the invention. FIG. 3 describes from the perspective of a user equipment and FIG. 4 describes from the perspective of the network/eNB. FIGS. 3-4 may each be considered to illustrate the operation of a method, and a result of execution of a computer program stored in a computer readable memory, and a specific manner in which components of an electronic device are configured to cause that electronic device to operate, whether such an electronic device is the UE or eNB, or one or more components thereof such as a modem, chipset, or the like. The various blocks shown in FIGS. 3-4 may also be considered as a plurality of coupled logic circuit elements constructed to carry out the associated function(s), or specific result of strings of computer program code or instructions stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

In the FIG. 3 embodiment, at block 302 the UE utilizes downlink control signaling to associate at least a first logical channel or radio bearer with a first component carrier in a licensed frequency band and to associate at least a second logical channel or radio bearer with a second component carrier in an unlicensed frequency band. At block 304 the UE utilizes the associations of block 302 to select or otherwise control which uplink data is sent on the first and on the second component carriers by multiplexing the uplink data on the at least first and the at least second logical channels or radio bearers. Thus the UE uses the associations it gets from the DL control signaling for selecting, at least partially, which of the UL data it multiplexes is sent on which of the logical channels/radio bearers and consequently on which of the licensed and unlicensed component carriers. The remainder of FIG. 3 gives more specific but non-limiting implementations of blocks 302 and 304.

Block 306 stipulates that the downlink control signaling of block 302 is received from an access node of an E-UTRAN communication system and the uplink data is user data which is multiplexed such that all the user data which is delay-sensitive is sent in the licensed frequency band. Such an access node may be an eNB or a relay node for example. In other embodiments apart from block 306 these teachings may be implemented in another CA type system other than an E-UTRAN/LTE system, and the uplink data of block 304 may include some or all control information such as acknowledgements/negative acknowledgements, measurement reports, and the like.

Block 308 specifies the above-detailed RRC signaling. Specifically, the DL control signaling of block 302 comprises a RRC_Connection_Reconfiguration message which semi-statically defines a multiplexing allowance for each of the at least first and the at least second logical channel or radio bearer.

Block 310 specifies the above-detailed MAC signaling. Specifically, the DL control signaling of block 302 comprises a MAC control element CE which comprises a tuple of information for each of the at least first and at least second logical channel or radio bearer identifying: a) the first or second component carrier with which the respective logical channel or radio bearer is associated; and b) a multiplexing status for the respective logical channel or radio bearer. The information tuple of block 310 is specified at block 312 to be an information triple which further identifies the respective logical channel or radio bearer.

Block 314 describes an exemplary embodiment of the UE's power scaling. In response to determining that a calculated total transmit power for transmitting the uplink data of block 304 exceeds a maximum total transmit power, block 314 more aggressively scales down transmit power for the uplink data which is mapped to the at least second logical channel as compared to power scaling done on transmit power for the uplink data which is mapped to the at least first logical channel, so as not to exceed the maximum total transmit power.

FIG. 4 is a logic flow diagram that illustrates from the perspective of a network access node such as an eNB or relay node. In the FIG. 4 embodiment, at block 402 the eNB (or component/s thereof such as a modem or a chipset) associates at least a first logical channel or radio bearer with a first component carrier in a licensed frequency band; at block 404 it associates at least a second logical channel or radio bearer with a second component carrier in an unlicensed frequency band; and at block 406 it arranges downlink control signaling to inform a user equipment of the associations for use in multiplexing uplink data on the at least first and the at least second logical channels or radio bearers. Arranging the signaling at block 406 does not necessarily mean sending it; the DL signaling according to these teachings may be arranged by one or more components of the eNB and sent to another component of the eNB before actual transmission to the UE. By example, the associations of block 402 and 404 are stored in a local memory of the eNB. The remainder of FIG. 4 gives more specific but non-limiting implementations of blocks 402, 404 and 406.

Block 408 specifies that the downlink control signaling that is arranged at block 406 is sent from an access node of an E-UTRAN communication system and the uplink data is user data which the downlink control signaling directs to be multiplexed such that all the user data which is delay-sensitive is sent in the licensed frequency band.

Block 410 specifies the above-detailed RRC signaling. Specifically, the DL control signaling that is arranged at block 406 comprises a RRC_Connection_Reconfiguration message which semi-statically defines a multiplexing allowance for each of the at least first and the at least second logical channel or radio bearer.

Block 412 specifies the above-detailed MAC signaling. Specifically, the DL control signaling that is arranged at block 406 comprises a medium access control MAC control element which comprises a tuple of information for each of the at least first and the at least second logical channel or radio bearer identifying: a) the first or second component carrier with which the respective logical channel or radio bearer is associated; and b) a multiplexing status for the respective logical channel or radio bearer. The information tuple of block 412 is specified at block 414 to be an information triple which further identifies the respective logical channel or radio bearer.

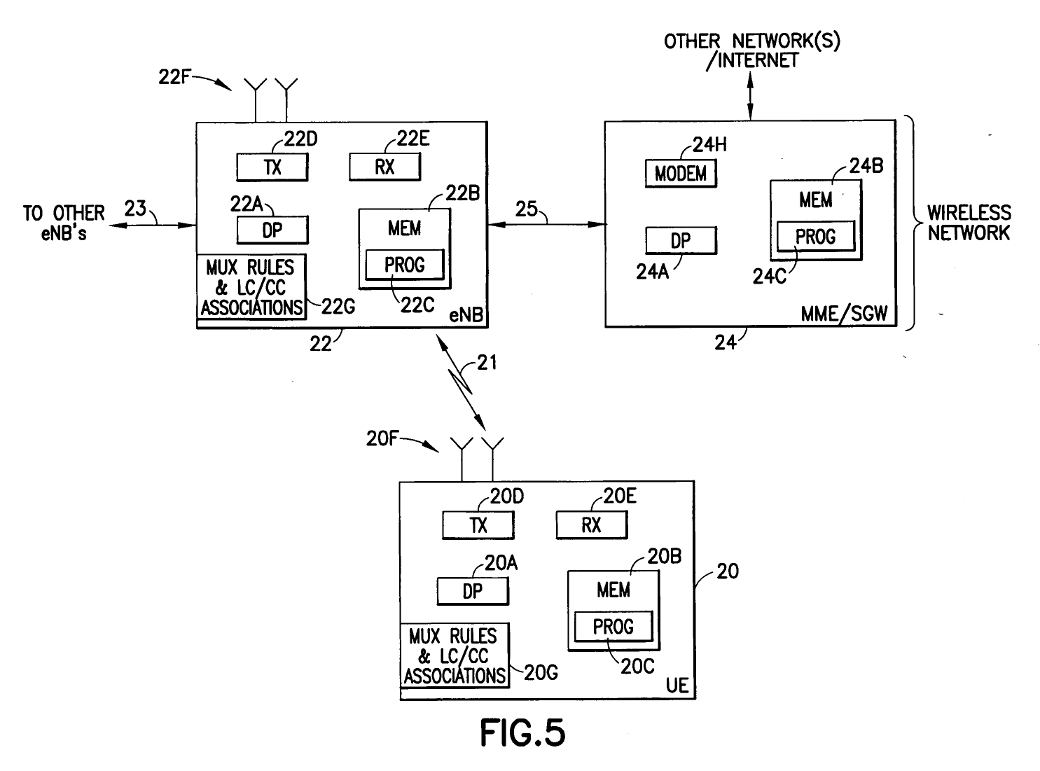

Reference is now made to FIG. 5 for illustrating a simplified block diagram of various electronic devices and apparatus that are suitable for use in practicing the exemplary embodiments of this invention. In FIG. 5 an eNB 22 is adapted for communication over a wireless link 21 with an apparatus, such as a mobile terminal or UE 20. The eNB 22 may be any access node (including relay nodes) of any wireless network using licensed and unlicensed bands, such as LTE, LTE-A, GSM, GERAN, WCDMA, and the like. The operator network of which the eNB 22 is a part may also include a network control element such as a MME/SGW 24 or RNC which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F. Also stored in the MEM 20B at reference number 20G are the multiplexing (MUX) rules which take into account the D1 signaling which associates the various logical channels with the various CCs as detailed in the examples above.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. The eNB 22 stores at block 22G similar multiplexing (MUX) rules which take into account the DL signaling which associates the various logical channels with the various CCs as detailed in the examples above. The eNB 22 consults these rules when making its DL resource assignments and when de-multiplexing the channels it receives from the scheduled UE.

While not particularly illustrated for the UE 20 or eNB 22, those devices are also assumed to include as part of their wireless communicating means a modem and/or a chipset which may be inbuilt on an RF front end chip within those devices 20, 22 and which also operates utilizing the associations given in the DL signaling between the logical channels and the CCs.

At least one of the PROGs 20C in the UE 20 is assumed to include a set of program instructions that, when executed by the associated DP 20A, enable the device to operate in accordance with the exemplary embodiments of this invention, as detailed above. The eNB 22 also has software stored in its MEM 22B to implement certain aspects of these teachings. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 5 and having the protocol stack of FIG. 2 (without the NAS 202 for the network-side devices), but exemplary embodiments may be implemented by one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the E-UTRAN system, as noted above the exemplary embodiments of this invention are not limited for use with only this one particular type of wireless communication system.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least:
utilize downlink control signaling to associate at least a first logical channel or radio bearer with a first component carrier in a licensed frequency band and to associate at least a second logical channel or radio bearer with a second component carrier in an unlicensed frequency band; and
utilize the associations to control which uplink data is sent on the first and on the second component carriers by multiplexing the uplink data on the at least first and the at least second logical channels or radio bearers.

2. The apparatus according to claim 1, in which the downlink control signaling comprises a RRC_Connection_Reconfiguration message which semi-statically defines a multiplexing allowance for each of the at least first and the at least second logical channel or radio bearer.

3. The apparatus according to claim 1, in which the apparatus comprises one of a modem and a chipset.

4. The apparatus according to claim 1, in which the downlink control signaling is received from an access node of an E-UTRAN communication system and the uplink data is user data which is multiplexed such that all the user data which is delay-sensitive is sent in the licensed frequency band.

5. The apparatus according to claim 1, in which the downlink control signaling comprises a medium access control MAC control element which comprises a tuple of information for each of the at least first and the at least second logical channel or radio bearer identifying:
the first or second component carrier with which the respective logical channel or radio bearer is associated; and
a multiplexing status for the respective logical channel or radio bearer.

6. The apparatus according to claim 5, in which the tuple of information for each of the at least first and at least second logical channel or radio bearer is a triple of information, further identifying the respective logical channel or radio bearer.

7. The apparatus according to claim 1, in which the at least one memory with the computer program is configured with the at least one processor to cause the apparatus to at least further:
in response to determining that a calculated total transmit power for transmitting the uplink data exceeds a maximum total transmit power, scaling down transmit power for the uplink data which is mapped to the at least second logical channel more aggressively than transmit power for the uplink data which is mapped to the at least first logical channel, so as not to exceed the maximum total transmit power.

8. A method, comprising:
utilizing by an apparatus downlink control signaling to associate at least a first logical channel or radio bearer with a first component carrier in a licensed frequency band and to associate at least a second logical channel or radio bearer with a second component carrier in an unlicensed frequency band; and
utilizing the associations to control by the apparatus which uplink data is sent on the first and on the second component carriers by multiplexing the uplink data on the at least first and the at least second logical channels or radio bearers.

9. The method according to claim 8, in which the downlink control signaling comprises a RRC_Connection_Reconfiguration message which semi-statically defines a multiplexing allowance for each of the at least first and the at least second logical channel or radio bearer.

10. The method according to claim 8, in which the apparatus comprises one of a modem and a chipset.

11. The method according to claim 8, in which the downlink control signaling is received from an access node of an E-UTRAN communication system and the uplink data is user data which is multiplexed such that all the user data which is delay-sensitive is sent in the licensed frequency band.

12. The method according to claim 8, in which the downlink control signaling comprises a medium access control MAC control element which comprises a tuple of information for each of the at least first and the at least second logical channel or radio bearer identifying:
the first or second component carrier with which the respective logical channel or radio bearer is associated; and
a multiplexing status for the respective logical channel or radio bearer.

13. The method according to claim 12, in which the tuple of information for each of the at least first and at least second logical channel or radio bearer is a triple of information, further identifying the respective logical channel or radio bearer.

14. The method according to claim 8, the method further comprising:
in response to determining that a calculated total transmit power for transmitting the uplink data exceeds a maximum total transmit power, the apparatus scaling down transmit power for the uplink data which is mapped to the at least second logical channel more aggressively than transmit power for the uplink data which is mapped to the at least first logical channel, so as not to exceed the maximum total transmit power.

15. A computer readable memory storing a set of instructions, which, when executed by an apparatus, causes the apparatus to:
utilize downlink control signaling to associate at least a first logical channel or radio bearer with a first component carrier in a licensed frequency band and to associate at least a second logical channel or radio bearer with a second component carrier in an unlicensed frequency band; and
utilize the associations to control which uplink data is sent on the first and on the second component carriers by multiplexing the uplink data on the at least first and the at least second logical channels or radio bearers.

16. The computer readable memory according to claim 15, in which the downlink control signaling comprises a RRC_Connection_Reconfiguration message which semi-statically defines a multiplexing allowance for each of the at least first and the at least second logical channel or radio bearer.

17. The computer readable memory according to claim 15, in which the downlink control signaling is received from an access node of an E-UTRAN communication system and the uplink data is user data which is multiplexed such that all the user data which is delay-sensitive is sent in the licensed frequency band;
and in which the apparatus comprises at least one of a modem and a chipset.

18. The computer readable memory according to claim 15, in which the downlink control signaling comprises a medium access control MAC control element which comprises a tuple of information for each of the at least first and the at least second logical channel or radio bearer identifying:
the first or second component carrier with which the respective logical channel or radio bearer is associated; and
a multiplexing status for the respective logical channel or radio bearer.

19. The computer readable memory according to claim 18, in which the tuple of information for each of the at least first and at least second logical channel or radio bearer is a triple of information, further identifying the respective logical channel or radio bearer.

20. The computer readable memory according to claim 15, in which the set of instructions, when executed by the apparatus, further causes the apparatus to:
in response to a calculated total transmit power for transmitting the uplink data exceeding a maximum total transmit power, scale down transmit power for the uplink data which is mapped to the at least second logical channel more aggressively than transmit power for the uplink data which is mapped to the at least first logical channel, so as not to exceed the maximum total transmit power.

21.-38. (canceled)
